(19) United States
(12) Patent Application Publication
(10) Pub. No.: US 2004/0118593 A1
(43) Pub. Date: Jun. 24, 2004

(54) Flat tape cable separator

(76) Inventors: Kevin Augustine, Frankfort, KY (US); Amy Shackelford, O'Fallon, MO (US); Brad Davies, El Paso, TX (US)

Correspondence Address: BLANK ROME LLP, 600 NEW HAMPSHIRE AVENUE, N.W., WASHINGTON, DC, 20037, US

(21) Appl. No.: 10/324,127

(22) Filed: Dec. 20, 2002

(51) Int. Cl. H01B 11/02

(52) U.S. Cl. 174/113 R

(57) ABSTRACT

The present invention is directed to a high speed electrical data cable having a plurality of twisted pair conductors lying adjacent to one another and separated by at least two flat tape separators. In the preferred embodiment, the electrical cable has four twisted pairs wrapped in an insulation jacket and separated with four flat tape separators. The tape separators are made of a plastic foam material having a low dielectric constant to reduce the crosstalk between adjacent twisted pairs and consequently, improve the cable's electrical performance. The plastic foam material is also highly flexible, providing the data cable with a high degree of flexibility and workability.

### FIELD OF THE INVENTION

The present invention is directed to a data communications cable having twisted pairs of electrical conductors separated by flat planar tapes that reduce the amount of crosstalk and improve the electrical performance of the data cable.

### BACKGROUND OF THE INVENTION

High speed data communications cables that use pairs of twisted electrical conductors (“twisted pairs”) are well known in the art. A single electrical cable often uses several twisted pairs which are closely spaced together and have a layer of outer insulation wrapped around them. Unfortunately, the close proximity of the twisted pairs encourages electrical energy transfer from one twisted pair to another, which is commonly referred to as crosstalk.

One method of addressing the problem of crosstalk is to increase the spacing between twisted pairs by altering the twist lay or direction of twist of adjacent twisted pairs. A twisted pair is made up of two electrical conductors that are twisted around each other along their longitudinal length. The distance between the twists is referred to as the twist lay. When the twist lay and direction of twist of adjacent twisted pairs are identical, the twisted pairs tend to be more closely spaced. Therefore, by altering the twist lay or direction of twist, the spacing between the twisted pair is increased, and the amount of crosstalk reduced.

An alternative method of reducing crosstalk is shown in U.S. Pat. No. 6,248,954 to Clark et al. which shows in FIGS. 2-10 various cables having twisted pairs that are spaced apart using different types of separators, such as the star-shaped support 126 shown in FIG. 2, the wall protrusions 136 shown in FIG. 3, and a single tape separator 14 shown in FIGS. 4-11.

The use of the separators disclosed by Clark et al. all have their drawbacks. The star-shaped support 126 shown in FIG. 2 of Clark et al. is of limited value because any gain in cable performance by using the relatively large separator, is offset by the increase in size and fuel value of the cable. The cable's fuel value is the amount of material that is present in the cable that is capable of burning, so that a cable with a higher fuel value will burn longer and hotter. It is therefore desirable to have a cable with a low fuel value. Additionally, using a larger separator makes the cable more rigid, limiting its flexibility and workability.

The wall protrusions 136 shown in FIG. 3 of Clark et al. present many of the same disadvantages as the star-shaped separator of FIG. 2. The wall protrusions increase the fuel value of the cable and act as stiffeners to decrease the cable's flexibility. The wall protrusions are also difficult to manufacture, thereby increasing the cost of the cable. Furthermore, the wall protrusions interfere with the removal of the outer jacket from the cable, making the cable more difficult to strip.

The single tape separator 14 shown in FIGS. 4-11 solves some of the problems of the Clark et al. separators shown in FIGS. 2 and 3. However, the use of a single tape separator presents its own problems. As shown best in FIGS. 5-8, the single tape separator is bent into a variety of elaborate shapes, which are difficult to produce, making the cable expensive to manufacture.

Therefore, it would be advantageous to provide a simple tape separator that reduces the amount of crosstalk between twisted pairs, without reducing the cable's flexibility or increasing the cable's fuel value.

### SUMMARY OF INVENTION

The present invention is directed to a high speed electrical data cable having a series of twisted pair conductors lying adjacent to one another and separated by a plurality of flat tape separators. Preferably, the electrical cable has four twisted pairs wrapped in an insulation jacket and separated with two or four flat tape separators. The tape separators ensure that the twisted pairs do not contact one another, thereby reducing the amount of crosstalk between the twisted pairs. Consequently, the cable's electrical performance is improved. Also, the tape separators are relatively small, thin objects having a low fuel value, discouraging prolonged burning of the cable.

### BRIEF DESCRIPTION OF THE DRAWINGS

FIG. 1 is a perspective view of an electrical cable with a tape separator;

FIG. 2 is a cross-sectional end view of an electrical cable of the present invention having four tape separators;

FIG. 3 is a cross-sectional end view of the electrical cable of the present invention having two tape separators; and

FIG. 4 is a cross-sectional end view of the electrical cable of the present invention having a circular separator.

### DETAILED DESCRIPTION OF THE PREFERRED EMBODIMENTS

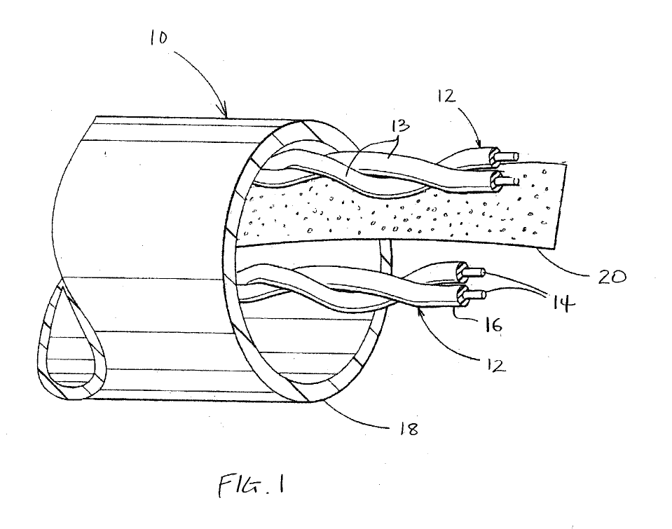

A detailed description of the invention is now given with reference to FIGS. 1-4. Although the embodiments shown in the figures are directed towards electrical data cables, the concepts and inventive principles contained herein are applicable to other types of cables. Additionally, the embodiments shown in the figures contain four pairs of twisted electrical conductors (twisted pairs), but it should be understood that the invention contemplates using any number of twisted pairs.

FIG. 1 shows a perspective view of an electrical high speed data cable 10 having a plurality of electrical twisted pair conductors 12. Each twisted pair 12 is made up of two conductors 13 that are twisted around each other along their longitudinal length. Each conductor 13 includes a conductive core 14, usually copper or other highly electrically conductive metal, surrounded by an insulative covering 16. A jacket 18 wraps around the twisted pairs 12 to form the single electrical cable 10.

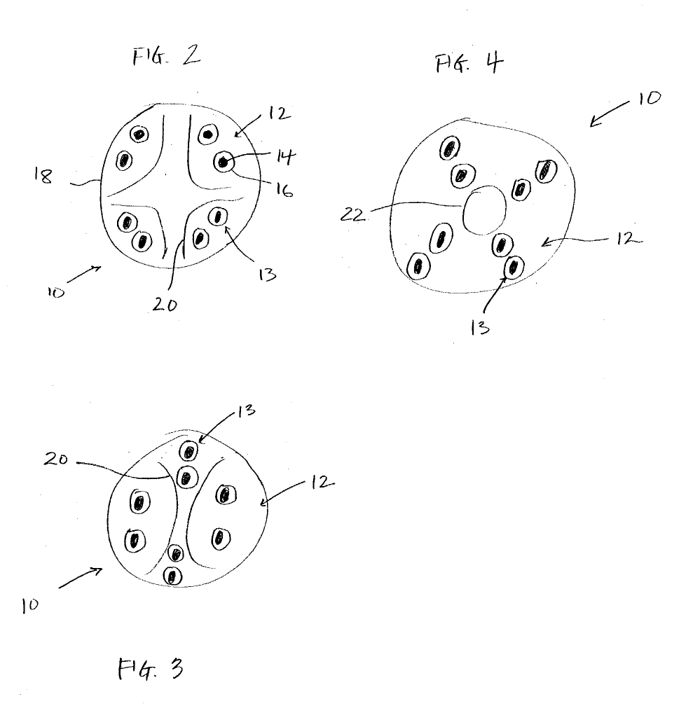

FIG. 1 only shows two twisted pairs and a single tape separator for purposes of clarity. However, the preferred embodiments of the invention, shown in FIGS. 2 and 3, include four twisted pairs and at least two tape separators.

Because the jacket 18 wraps the twisted pairs 12 in close proximity to one another, the electrical performance of the cable 10 is degraded because energy is transferred from one twisted pair to another. This energy transfer is commonly referred to as crosstalk. To reduce the amount of crosstalk, separators 20 are placed between the twisted pairs 12. Each separator 20 is generally a flat, flexible tape made up of a lightweight, flame retardant plastic, with a low dielectric constant. A variety of materials can be used for the separator, including but not limited to a solid or foamed form of a polyolefin, a fluoropolymer, a fluorinated ethylene propylene or a polyvinyl chloride.

FIG. 2 shows a preferred embodiment of the invention having four twisted pairs 12 and four tape separators 20, with each tape separator 20 placed around each twisted pair 12. Each tape separator 20 is made of a flexible plastic that is curved around its respective twisted pair 12 to situate it against an inner wall of the jacket 18. Each twisted pair 12 is isolated by its own tape separator 20 and thereby shielded from the other twisted pairs by at least two layers of separators 20.

FIG. 3 shows a second embodiment of the invention that uses two separators 20. The two tape separators 20 are curved around opposing twisted pairs to situate them against the inner wall of the jacket 18. The apex of the two curved tape separators 20 approach each other at the center of the cable 10, thereby separating the two remaining twisted pairs. Because there are only two tape separators, this embodiment is less effective in reducing crosstalk when compared to the first embodiment, however, because there fewer separators, this embodiment also has a lower fuel value, is easier to assemble, uses less material, and is cheaper to manufacture.

FIG. 4 shows another embodiment of the invention having a circular pipe 22 that extends along center of the cable 10. The pipe 22 can be hollow or filled with a insulating material to reduce the amount of crosstalk. The pipe 22 keeps the twisted pairs 12 from converging on the center of the cable 10, and maintains a degree of separation of the twisted pairs 12. However, there is no barrier separating the sides of the twisted pairs from one another, thereby decreasing the effectiveness of the shielding.

Although certain presently preferred embodiments of the present invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. An electrical data cable having reduced crosstalk characteristics comprising:
a plurality of twisted wire pairs wrapped by a cable jacket, each twisted wire pair comprising two electrical conductors twisted along their longitudinal length;
at least two generally flat tape separators placed in between the plurality of twisted wire pairs to reduce the electrical interference between adjacent twisted wire pairs, the tape separators being flexible and curved around one of said plurality of twisted wire pairs to situate said curved around one of said plurality of twisted wire pairs against the cable jacket.

2. The electrical data cable of claim 1, wherein the electrical cable has four twisted pairs and two tape separators, said tape separators curved around opposing twisted pairs to situate said opposing twisted pairs against the cable jacket, said tape separators having an apex converging at the center of the cable to block the remaining two twisted pairs from contacting one another.

3. The electrical data cable of claim 2, wherein the tape separators are made of a plastic foam-like material.

4. The electrical data cable of claim 1, wherein the electrical cable has four twisted pairs and four tape separators, each tape separator situating each twisted pair against the cable jacket

5. The electrical data cable of claim 4, wherein the tape separators are made of a plastic foam-like material.

6. An electrical data cable for reducing crosstalk comprising:
a plurality of electrical twisted pairs wrapped by a cable jacket, each twisted pair comprising two electrical conductors twisted along their longitudinal length;
a circular separator in the center of the cable extending along its longitudinal length, the circular separator maintaining the spacing of the twisted pairs so that they do not come into contact with one another.
